(19) United States
(12) Patent Application Publication
(10) Pub. No.: US 2009/0046541 A1
(43) Pub. Date: Feb. 19, 2009

(54) ELECTRONIC DEVICE WITH AN ALARM CLOCK FUNCTION AND METHOD OF CONTROLLING THE FUNCTION

(75) Inventors: CHENG-HAO CHOU, Tu-Cheng (TW); LI WANG, Shenzhen City (CN); BO-CHING LIN, Tu-Cheng (TW); XIAO-GUANG LI, Shenzhen City (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/185,128

(22) Filed: Aug. 4, 2008

(30) Foreign Application Priority Data
Aug. 15, 2007 (CN) 200710075697.9

(51) Int. Cl. G04B 23/03

(52) U.S. Cl. 368/262

(57) ABSTRACT

An electronic device with an alarm clock function includes a storage unit storing a plurality of questions, corresponding answers, a preset number and a count number; a managing unit for performing or disabling an alarm clock function; a random selection module for generating and outputting a random question; a comparison module for receiving inputs and determining whether the input matches the corresponding answer; a recording module for adding 1 to the count number when the input matches the corresponding answer; and a number confirming module for comparing the count number with the preset number, disabling the alarm clock function when the count number is equal to the preset number, and informing the random selection module to re-generate a random question when the count number is not equal to the preset number. A method of disabling alarm clock function is also provided.

### BACKGROUND

1. Technical Field

The present invention relates to an electronic device with an alarm clock function that can effectively wake-up a user.

2. General Background

Waking up in the morning or simply being on time is a difficult proposition for many people. It is quite common for people to use alarm clocks to wake or alert themselves at a pre-determined time. A user can press a particular or any key to turn off the alarm clock. Unfortunately, the user may inadvertently turn off the alarm when he or she is groggy from waking up. This sometimes leads to oversleeping. Moreover, the user may not realize he or she has turned off the alarm.

To counteract this problem, some people use what is commonly known as a snooze function, however people may disable this function as well without fully awakening. If the alarm clock can be turned off only when the user is clear-headed, that would be more effective.

Therefore, an alarm clock function that can wake the user up effectively is needed.

### SUMMARY

An electronic device with an alarm clock function includes a storage unit storing a plurality of questions, corresponding answers, a preset number and a count number; a managing unit for performing or disabling an alarm clock function; a random selection module for generating and outputting a random question; a comparison module for receiving inputs and determining whether the input matches the corresponding answer; a recording module for adding 1 to the count number when the input matches the corresponding answer; and a number confirming module for comparing the count number with the preset number, disabling the alarm clock function when the count number is equal to the preset number, and informing the random selection module to re-generate a random question when the count number is not equal to the preset number.

Other advantages and novel features will be drawn from the following detailed description with reference to the attached drawings.

### BRIEF DESCRIPTION OF THE DRAWINGS

The components of the drawings are not necessarily drawn to measuring scale, the emphasis instead being placed upon clearly illustrating the principles of the electronic device with an alarm clock function that can effectively wake-up a user. Moreover, in the drawings, like reference numerals designate corresponding parts throughout the several views.

FIG. 1 is an exemplary block diagram of a hardware infrastructure of an electronic device with an alarm clock function in accordance with an exemplary embodiment of the invention.

FIG. 2 is an exemplary block diagram of main function modules of a processing unit in the electronic device of FIG. 1.

FIG. 3 is a flowchart of a method of disabling the alarm clock function of the electronic device of FIG. 1 in accordance with an exemplary embodiment of the invention.

### DETAILED DESCRIPTION OF THE EMBODIMENT

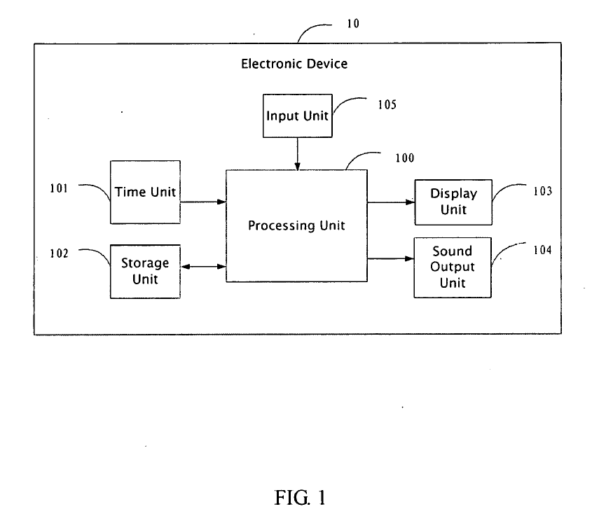

FIG. 1 is an exemplary block diagram of a hardware infrastructure of an electronic device with an alarm clock function in accordance with an exemplary embodiment of the invention. The electronic device 10 includes a processing unit 100, a time unit 101, a storage unit 102, a display unit 103, a sound output unit 104, and an input unit 105.

The time unit 101 is used for supplying the current time. The display unit 103 and the sound output unit 104 are used for outputting video or sound information according to an instruction of the processing unit 100. The input unit 105 is used for receiving a user's input. The storage unit 102 is used for storing an alarm time, alarm modes, a database, a preset number, and a count number. The alarm modes include, but are not limited to, a ring mode and a vibration mode. The database includes a plurality of questions and corresponding answers. The count number represents a count of a user's correct inputs. The alarm time is set by the user and indicates a time of performing an alarm clock function. The preset number indicates the number of times that the user must input a correct answer. When the count number equals the preset number, the alarm clock function is disabled.

When the alarm clock function is performed, the processing unit 110 generates a random question, and outputs the random question via the display unit 103 or the sound output unit 104, e.g. “1+2=?”, and so on. The processing unit 100 receives inputs from the user and determines whether the input matches the corresponding answer, e.g. “3” corresponding to “1+2=?”. When the input matches the corresponding answer, the processing unit 100 adds 1 to the count number, and determines whether the count number is equal to the preset number. If the count number is equal to the preset number, the processing unit 100 disables the alarm clock function. If the count number is less than the preset number, the processing unit 100 re-generates a random question.

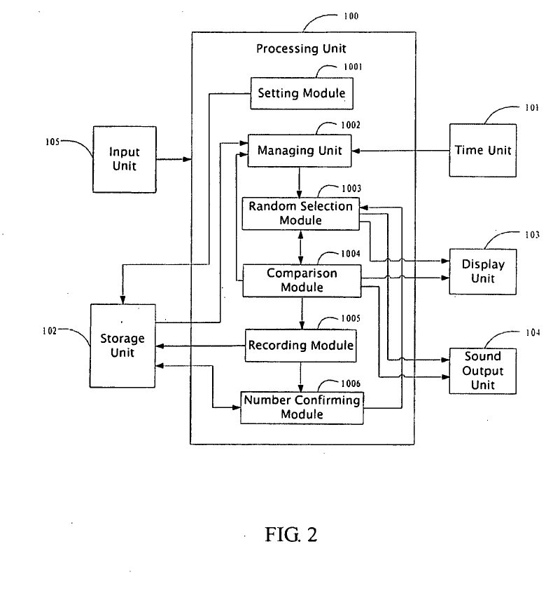

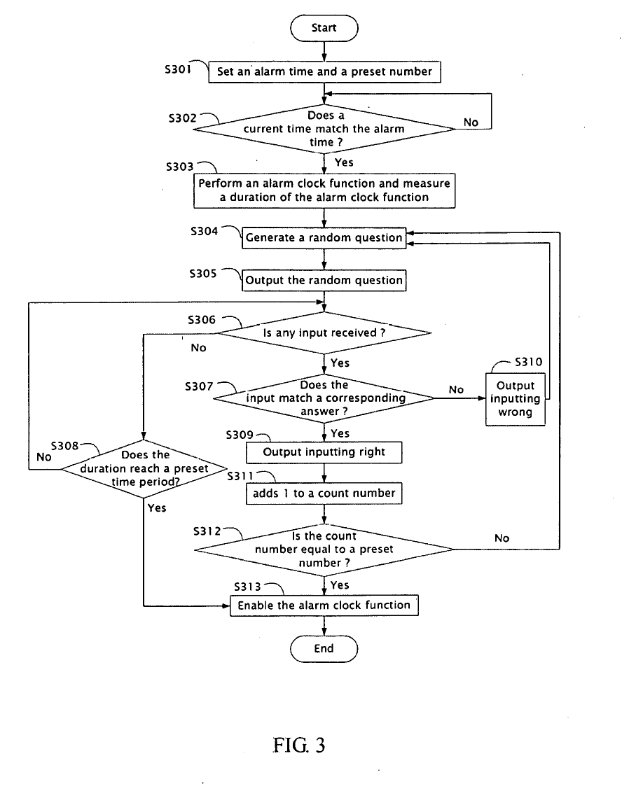

FIG. 2 is an exemplary block diagram of main function modules of the processing unit 100. The processing unit 100 includes a setting module 1001, a managing unit 1002, a random selection module 1003, a comparison module 1004, a recording module 1005, and a number confirming module 1006. The functions of the modules in the processing unit 100 are described below together with FIG. 3.

FIG. 3 is a flowchart of a method of disabling the alarm clock function of the electronic device in accordance with an exemplary embodiment.

In step S301, the setting module 1001 sets the alarm time, the alarm mode, and the preset number, via the input unit 105, and stores these settings in the storage unit 102. However, the alarm mode and the preset number can also be pre-stored in the storage unit 102.

In step S302, the managing unit 1002 periodically obtains the current time from the time unit 101, and determines whether current time matches the alarm time. If the current time does not match the alarm time, the managing unit 1002 repeats step S302.

When the current time is the alarm time, in step S303, the managing unit 1002 obtains the alarm mode from the storage unit 102, performs the alarm clock function, informs the time unit 101 to measure a duration the alarm clock function is performed, and generates a random selecting signal to the random selection module 1003.

In step 304, the random selection module 1003 generates a random question according to the random selecting signal.

In step S305, the random selection module 1003 sends the random question to the display unit 103 or the sound input unit 104.

In step S306, the comparison module 1004 detects whether inputs from the user is received from the input unit 105.

In step S307, if input is received from the input unit 105, the comparison module 1004 determines whether the inputs matches the corresponding answer.

If no input is received from the input unit 105, in step S308, the comparison module 1004 determines whether the duration of the alarm clock function reaches a preset time period. If the duration of the alarm clock function is less than the preset time period, the procedure returns to step 306. If the duration of the alarm clock is equal to the preset time period, the procedure goes to step S313 described below.

If the input matches the corresponding answer, in step S309, the comparison module 1004 outputs a first result, such as “right input”, via the display unit 103 or sound output unit 104, and sends a determining signal to the recording module 1005, and the procedure goes to step S311.

If the input does not match the corresponding answer, in step S310, the comparison module 1004 outputs a second result, such as “wrong input”, via the display unit 103 or sound output unit 104, and the procedure returns to step S304.

In step S311, the recording module 1005 adds 1 to the count number according to the determining signal.

In step S312, the number confirming module 1006 determines whether the count number is equal to the preset number. If the count number is not equal to the preset number, the procedure returns to step S304.

If the count number is equal to the preset number, in step S313, the managing unit 1002 disables the alarm clock function, and resets the count number.

In addition, in another embodiment of the invention, in step S310, if the input does not match the corresponding answer, the comparison module 1004 outputs the second result via the display unit 103 or sound output unit 104, and the procedure returns to step S306, but not to step S304.

Although the present invention has been specifically described on the basis of an exemplary embodiment thereof, the invention is not to be construed as being limited thereto. Various changes or modifications may be made to the embodiment without departing from the scope and spirit of the invention.

What is claimed is:

1. An electronic device with an alarm clock function, the electronic device comprising:
a storage unit storing a plurality of questions, corresponding answers, a preset number and a count number;
a managing unit for performing or disabling an alarm clock function;
a random selection module for generating and outputting a random question;
a comparison module for receiving inputs and determining whether the input matches the corresponding answer;
a recording module for adding 1 to the count number when the input matches the corresponding answer; and
a number confirming module for comparing the count number with the preset number, disabling the alarm clock function when the count number is equal to the preset number, and informing the random selection module to re-generate a random question when the count number is not equal to the preset number.

2. The electronic device according to claim 1, wherein the managing unit is further used for informing the time unit to measure a duration of the alarm clock, and disabling the alarm clock function when the duration is equal to a preset time.

3. The electronic device according to claim 2, wherein the random selection module is further used for outputting a result when the input matches the corresponding answer.

4. The electronic device according to claim 3, wherein the comparison module is further used for informing the random selection module to generate the random question when the input does not match the corresponding answer.

5. The electronic device according to claim 1, wherein the comparison module is further used to receiving inputs and determining whether the input matches the corresponding answer.

6. A method of disabling an alarm clock function, the method comprising:
supplying a storage unit for storing a plurality of questions, corresponding answers, a preset number, and a count number;
generating and outputting a random question;
receiving inputs and determining whether the input matches the random question;
adding 1 to the count number when the input matches the corresponding answer;
comparing the count number with the preset number;
disabling the alarm clock function when the count number is equal to the preset number; or
re-generating a random question when the count number is not equal to the preset number.

7. The method according to claim 6, further comprising measuring a duration of the alarm clock; and disabling the alarm clock function when the duration is equal to a preset time.

8. The method according to claim 6, further comprising outputting a result after confirming the input with the corresponding answer.

9. The method according to claim 6, further comprising generating the random question when the input does not match the corresponding answer.

10. The method according to claim 9, further comprising receiving inputs and determining whether the input matches the corresponding answer.
